(19) United States
(12) Patent Application Publication
(10) Pub. No.: US 2026/0084494 A1
(43) Pub. Date: Mar. 26, 2026

(54) CARTRIDGE FOR VEHICLE-MOUNTED ACCESSORY DEVICE

(71) Applicant: Kojima Industries Corporation, Toyota-shi (JP)

(72) Inventors: Fumihiro ONOGI, Toyota-shi (JP); Takahiro SUZUKI, Toyota-shi (JP); Hitoshi TAMURA, Toyota-shi (JP); Kiyokazu KOYASU, Toyota-shi (JP)

(21) Appl. No.: 19/331,488

(22) Filed: Sep. 17, 2025

(30) Foreign Application Priority Data
Sep. 20, 2024 (JP) 2024-164075

(51) Int. Cl. B60H 3/00; B60R 16/03

(52) U.S. Cl. CPC B60H 3/0007; B60R 16/03; B60H 2003/0057

(57) ABSTRACT

A cartridge has a cylindrically-shaped housing that can be inserted into and removed from an insertion guide of a fragrance unit, and a plurality of contact conductors provided at a tip of the cylindrically-shaped housing. The plurality of contact conductors are disposed at positions of N-fold rotational symmetry with an axis in an insertion/removal direction of the cylindrically-shaped housing as a center, wherein N is an integer greater than or equal to 2. When the cylindrically-shaped housing is inserted into the insertion guide, each of a plurality of contact terminals provided on the fragrance unit contacts a contact conductor corresponding to a rotational angle about the axis in the insertion/removal direction.

### CROSS REFERENCE TO RELATED APPLICATION

The present invention claims priority under 35 U.S.C. § 119 to Japanese Patent Application No. 2024-164075 filed on Sep. 20, 2024, which is incorporated herein by reference in its entirety including the specification, claims, drawings, and abstract.

### TECHNICAL FIELD

The present disclosure relates to a cartridge for a vehicle-mounted accessory device, and in particular to a cartridge which can be inserted into and removed from a vehicle-mounted accessory device.

### BACKGROUND

There are cases in which a fragrance unit (fragrance generation apparatus) is mounted in a vehicle cabin of an automobile as a vehicle-mounted accessory device. A cartridge of a cylindrical shape, which is a component housing an air freshener, is inserted into the fragrance unit. A plurality of cartridges corresponding to a plurality of fragrances are provided, and the fragrance unit generates a fragrance corresponding to the cartridge. By switching the cartridge from a cartridge generating a certain fragrance to another cartridge generating another fragrance, the fragrance generated by the fragrance unit is changed.

JP 2023-44594 A discloses a vehicle-mounted intelligent fragrant generator serving as such a fragrance unit. An air freshener container housing an air freshener is inserted into the vehicle-mounted intelligent fragrant generator, and the vehicle-mounted intelligent fragrant generator generates a fragrance with the air freshener. An identification circuit board provided in the vehicle-mounted intelligent fragrant generator and the air freshener container are electrically connected to each other by terminals provided respectively on these elements contacting each other. The vehicle-mounted intelligent fragrant generator reads ID information from an ID identification chip provided on the air freshener container and displays information of the fragrance type or the like on a vehicle-mounted display or the like as information related to the ID information.

In the fragrance unit of the related art, a configuration is employed in which the cartridge can be inserted into the fragrance unit when a rotational angle about an axis in a longitudinal direction of the cartridge of the cylindrical shape is a predefined rotational angle. This configuration is employed in order to enable predefined ones of a plurality of terminals provided on the cartridge to contact predefined ones of a plurality of terminals provided on the fragrance unit, to thereby enable the fragrance unit to read information from the cartridge. With this configuration, however, there have been cases where an insertion operation of the cartridge into the fragrance unit by the user becomes difficult.

An advantage of the present disclosure lies in facilitation of insertion of the cartridge into the vehicle-mounted accessory device such as the fragrance unit.

### SUMMARY

According to one aspect of the present disclosure, there is provided a cartridge for a vehicle-mounted accessory device, the cartridge comprising: a cylindrically-shaped housing that can be inserted into and removed from an insertion guide of a vehicle-mounted accessory device; and a plurality of contact conductors provided at a tip of the cylindrically-shaped housing, wherein the plurality of contact conductors are disposed at positions of N-fold rotational symmetry with an axis in an insertion/removal direction of the cylindrically-shaped housing as a center, wherein N is an integer greater than or equal to 2, and, when the cylindrically-shaped housing is inserted into the insertion guide, each of a plurality of contact terminals provided on the vehicle-mounted accessory device contacts a contact conductor, among the plurality of contact conductors, corresponding to a rotational angle about the axis in the insertion/removal direction.

In an embodiment of the present disclosure, the cylindrically-shaped housing is guided by the insertion guide in the insertion/removal direction at a rotational angle of the N-fold rotational symmetry with the axis in the insertion/removal direction as a center.

In an embodiment of the present disclosure, the cartridge further comprises a reference conductor provided at the tip of the cylindrically-shaped housing, and that surrounds, annularly or in an arc shape, the plurality of contact conductors disposed at the positions of the N-fold rotational symmetry, wherein, when the cylindrically-shaped housing is inserted into the insertion guide, a reference contact terminal provided on the insertion guide contacts the reference conductor.

In an embodiment of the present disclosure, the cartridge further comprises a center contact conductor provided at the tip of the cylindrically-shaped housing, and provided on a rotational axis of the N-fold rotational symmetry.

In an embodiment of the present disclosure, contact conductors, among the plurality of contact conductors, which are positioned at the same position when the cartridge is rotated by 360°/N about the axis in the insertion/removal direction from a certain rotational angle, are in electrical conduction with each other.

According to another aspect of the present disclosure, there is provided a cartridge for a vehicle-mounted accessory device, the cartridge comprising: a cylindrically-shaped housing that can be inserted into and removed from an insertion guide of a vehicle-mounted accessory device; and a plurality of contact conductors provided at a tip of the cylindrically-shaped housing, wherein the plurality of contact conductors form one or more rings and/or one or more arcs of different extents of curvature when viewing an axis in an insertion/removal direction of the cylindrically-shaped housing at an inner side, and are arranged in an order from a higher extent of curvature to a lower extent of curvature, from an inner side toward an outer side, and, when the cylindrically-shaped housing is inserted into the insertion guide, each of a plurality of contact terminals provided on the insertion guide contacts a corresponding contact conductor among the plurality of contact conductors.

In an embodiment of the present disclosure, the plurality of contact conductors form one or more circles and/or one or more arcs of different radii of curvature and are disposed concentrically.

In an embodiment of the present disclosure, the cartridge further comprises a center contact conductor provided at the tip of the cylindrically-shaped housing, and provided at a position surrounded by the plurality of contact conductors.

In an embodiment of the present disclosure, the vehicle-mounted accessory device is a fragrance generation apparatus.

According to an aspect of the present disclosure, insertion of the cartridge into the vehicle-mounted accessory device can be facilitated.

### BRIEF DESCRIPTION OF DRAWINGS

Embodiment(s) of the present disclosure will be described based on the following figures, wherein:

FIG. 1 is a perspective diagram of a fragrance unit and a cartridge;

FIG. 2 is a perspective diagram of the fragrance unit and the cartridge;

FIG. 3 is a cross-sectional diagram of the fragrance unit and the cartridge;

FIG. 4 is a perspective diagram of a contact point pin board and contact point pins;

FIG. 5 is a perspective diagram of a tip of the cartridge and the contact point pins;

FIG. 6 is a diagram showing a back surface of the cartridge;

FIG. 7 is a diagram showing the back surface of the cartridge along with the contact point pins;

FIG. 8 is a diagram showing the back surface of the cartridge;

FIG. 9 is a cross-sectional diagram of a cartridge board;

FIG. 10 is a diagram showing a back surface of a cartridge board according to a second embodiment of the present disclosure; and

FIG. 11 is a diagram showing a back surface of a cartridge board according to a third embodiment of the present disclosure.

### DESCRIPTION OF EMBODIMENTS

Embodiments of the present disclosure will now be described with reference to the drawings. Identical constituent elements illustrated in a plurality of drawings are assigned the same reference numerals and will be only briefly described. Further, a term representing a shape with a modifier “approximate” or “approximately” in the present disclosure means a shape which is geometrically defined, and also a shape deformed from the geometrically defined shape within a range in which the function of the member having the shape is realized.

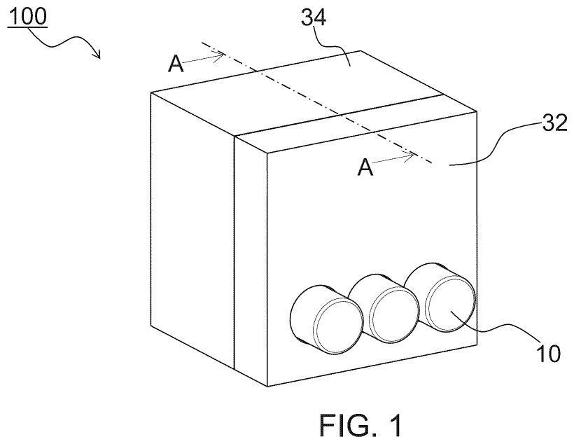

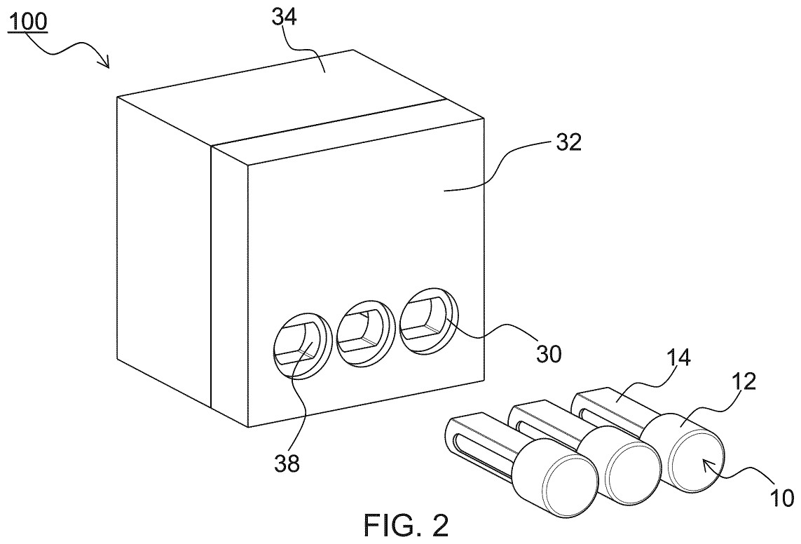

FIG. 1 and FIG. 2 are perspective diagrams showing a fragrance unit 100 (fragrance generation apparatus) and a cartridge 10 (cartridge for a vehicle-mounted accessory device) according to a first embodiment of the present disclosure. The fragrance unit 100 is a device classified as a vehicle-mounted accessory device, similar to an air conditioner, an audio device, a car navigation system, and the like.

The fragrance unit 100 is, for example, fixed on a console with a front-surface panel 32 facing a vehicle cabin side. In the following description, directions are defined such that a direction of the front-surface panel 32 facing the vehicle cabin side will be referred to as a front side, and an up-and-down direction in FIG. 1 and FIG. 2 is referred to as an up-and-down direction of the fragrance unit 100. The cartridge 10 which houses an air freshener can be inserted into and removed from the fragrance unit 100. FIG. 1 shows a state in which three cartridges 10 are inserted into the fragrance unit 100, and FIG. 2 shows a state before the three cartridges 10 are inserted into the fragrance unit 100.

The cartridge 10 is formed from a knob portion 12 and a cylindrically-shaped housing 14. The cylindrically-shaped housing 14 is a portion which is inserted into the fragrance unit 100. The knob portion 12 is a portion where a width is widened in a direction perpendicular to a longitudinal direction (insertion/removal direction) of the cylindrically-shaped housing 14, and which is pinched by a user. In the example configuration illustrated in FIG. 2, the knob portion 12 is formed in an approximate circular cylindrical shape, and the cylindrically-shaped housing 14 is formed in an approximate quadrangular cylindrical shape.

The fragrance unit 100 generates fragrance in the vehicle cabin using an air freshener housed in the cylindrically-shaped housing 14 of the cartridge 10. In the fragrance unit 100 of the present embodiment, three cartridge openings 30, into and from which the cartridges 10 can be inserted and removed, are formed on the front-surface panel 32. Three cartridges 10 having different kinds of the air fresheners may be inserted into the three cartridge openings 30. For the fragrance unit 100, an operation to select one of the three cartridges 10 is performed by the user. The fragrance unit 100 generates a fragrance based on the air freshener housed in the selected one of the three cartridges 10.

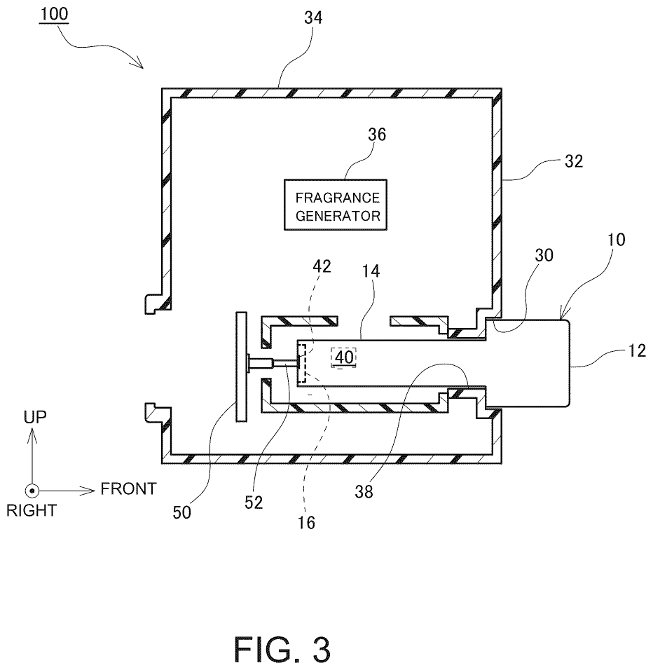

FIG. 3 is a cross-sectional diagram of the fragrance unit 100 and the cartridge 10, along a line AA shown in FIG. 1. The fragrance unit 100 comprises the front-surface panel 32, a body housing 34, and a fragrance generator 36. A front side of the body housing 34 is covered by the front-surface panel 32. The fragrance generator 36 is an electric device which generates fragrance based on the air freshener housed in the cartridge 10. The fragrance generator 36 is housed in the body housing 34. For the purpose of explanation, the fragrance generator 36 is schematically drawn.

On the body housing 34, an insertion guide 38 into which the cartridge 10 is inserted is formed at a lower side. The insertion guide 38 is formed behind the cartridge openings 30 formed on the front-surface panel 32. The insertion guide 38 may be a wall surface which forms a tube which extends from the cartridge openings 30 into the fragrance unit 100.

The insertion guide 38 guides the cylindrically-shaped housing 14 of the cartridge 10 in a front-and-rear direction while keeping a rotational angle of the cylindrically-shaped housing 14 about its axis constant. The insertion guide 38 of the present embodiment guides the cylindrically-shaped housing 14 with respect to a certain rotational angle of the cylindrically-shaped housing 14 and also guides the cylindrically-shaped housing 14 which is in a state of being rotated from the above-described state by 180° about the axis of the cylindrically-shaped housing 14. That is, even when an orientation of the cartridge 10 is reversed in the up-and-down direction, the insertion guide 38 can guide the cylindrically-shaped housing 14 in the front-and-rear direction. In addition, the cylindrically-shaped housing 14 has a shape which enables such forms of guidance.

The insertion guide 38 may have a rail structure which guides the cylindrically-shaped housing 14 from the cartridge openings 30 into the fragrance unit 100. The rail structure may be formed from a plurality of bar-shaped members extending along the side surfaces of the cylindrically-shaped housing 14. The plurality of bar-shaped members may be configured to support the cartridge 10 around the cylindrically-shaped housing 14, and to guide the cylindrically-shaped housing 14 in the front-and-rear direction. In this case, a groove to which the bar-shaped member is fitted may be formed on the cylindrically-shaped housing 14.

The cartridge 10 comprises a memory 40 storing cartridge information. The cartridge information may include information for identifying the cartridge 10, information indicating the kind of the fragrance, information representing a remaining amount of the air freshener, and the like. As will be described later, at a tip of the cartridge 10, a plurality of contact conductors 42 for reading the cartridge information from the memory 40 are provided. The tip of the cartridge 10 refers to an end on a side toward a deeper part of the insertion guide 38, in the cartridge 10 which is inserted from the cartridge opening 30 into the insertion guide 38.

At a rear part of a space into which the insertion guide 38 and the cartridge 10 are inserted, a contact point pin board 50 extending in up-and-down and left-and-right directions is provided. From the contact point pin board 50, a plurality of contact point pins 52 extends toward the front side, as a plurality of contact terminals. In a state in which the cartridge 10 is inserted into the insertion guide 38, each of the plurality of contact conductors 42 provided at the tip of the cartridge 10 contacts a corresponding one of the plurality of contact point pins 52. In this state, the fragrance generator 36 reads the cartridge information from the memory 40 provided in the cartridge 10. The fragrance unit 100 may execute processes to display the kind of the fragrance, to display the remaining amount of the air freshener, or the like. This display may be realized by the fragrance generator 36 commanding a display provided on the console of the vehicle cabin or the like.

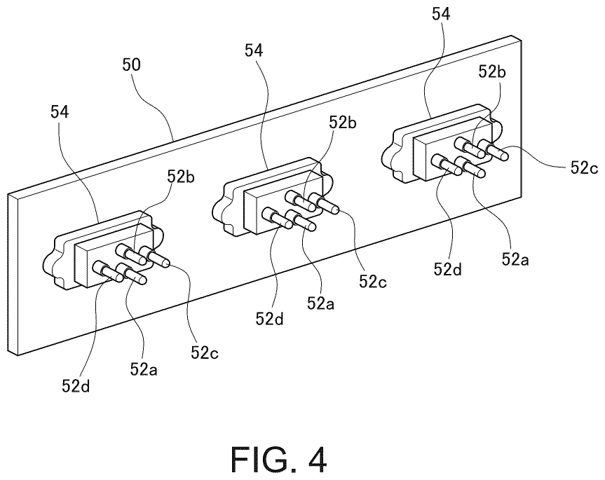

FIG. 4 is a perspective diagram showing the contact point pin board 50 and contact point pins 52a to 52d. In the example configuration illustrated in FIG. 4, on a front surface of the contact point pin board 50, a pin fixation base 54 formed from an insulator is fixed. From the pin fixation base 54, four contact point pins 52a to 52d extend toward the front side. A rear end of each contact point pin is electrically connected to a conductor pattern provided on the contact point pin board 50.

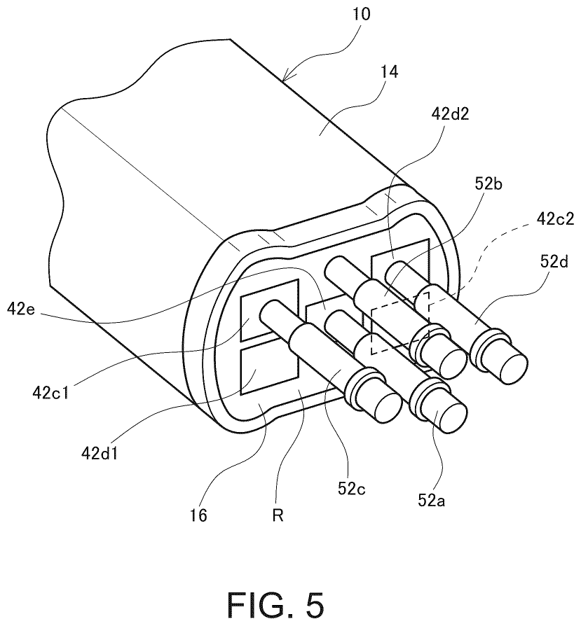

FIG. 5 is a perspective diagram of the tip of the cartridge 10, and the contact point pins 52a, 52b, 52c, and 52d. At the tip of the cartridge 10, a cartridge board 16 which extends in the up-and-down and left-and-right directions is provided. On a back surface of the cartridge board 16, five contact conductors 42c1, 42d1, 43e, 42d2, and 42c2, and one reference conductor R surrounding these five contact conductors are provided. In the example configuration illustrate in FIG. 5, in a state in which the cartridge 10 is inserted into the insertion guide 38, the contact conductor 42e, the reference conductor R, and the contact conductors 42c1 and 42d2 are provided at respective positions of tips of corresponding ones of the four contact point pins 52a, 52b, 52c, and 52d.

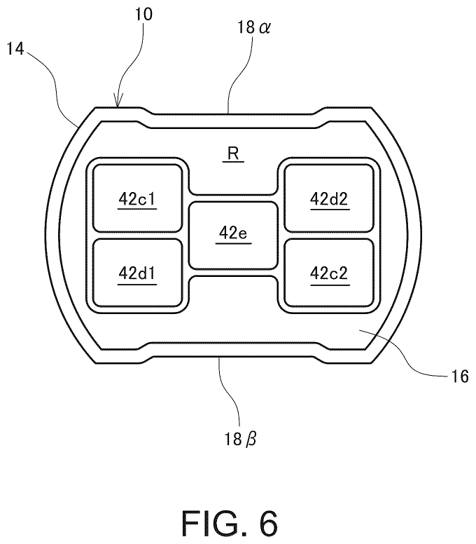

FIG. 6 shows the back surface of the cartridge 10. A cross section perpendicular to the axial direction of the cylindrically-shaped housing 14 has a shape of an approximate rectangle, enlarged in the left-and-right direction. On two surfaces facing opposite directions in the up-and-down direction, recesses 18α and 18β extending in a longitudinal direction of the cylindrically-shaped housing 14 are respectively formed. Protruding structures which enter the recesses 18α and 18β of the cylindrically-shaped housing 14 may be provided on the insertion guide 38 of the fragrance unit 100. When the cartridge 10 is inserted into the insertion guide 38, the user may move the cartridge 10 in its longitudinal direction such that the protruding structures move along the recesses 18α and 18β of the cylindrically-shaped housing 14, so that the cartridge is guided in the longitudinal direction.

The contact conductor 42c1 is disposed at an upper left part of the back surface of the cartridge board 16, and the contact conductor 42d1 is disposed at a lower left part. In addition, the contact conductor 42d2 is disposed at an upper right part of the back surface of the cartridge board 16, and the contact conductor 42c2 is disposed at a lower right part. The contact conductor 42e is disposed at a position between the contact conductors 42c1 and 42c2 and sandwiched by the contact conductors 42d2 and 42d1. That is, the contact conductor 42e is disposed as a center contact conductor at a position surrounded by the contact conductors 42c1, 42d1, 42d2, and 42c2 (near a center of the back surface of the cartridge board 16). In addition, on the back surface of the cartridge board 16, the reference conductor R surrounding the contact conductors 42c1, 42d1, 42e, 42d2, and 42c2 is provided. A shape of the reference conductor R may be an annular shape or an arc shape surrounding the contact conductors 42c1, 42d1, 42e, 42d2, and 42c2.

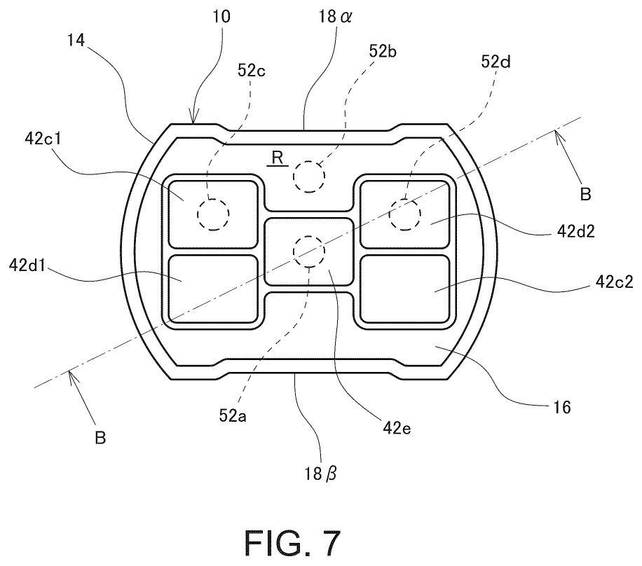

FIG. 7 shows, with dashed lines, the contact point pins 52c, 52a, and 52d (contact terminals) which respectively contact the contact conductors 42c1, 42e, and 42d2, and the contact point pin 52b (reference contact terminal) which contacts the reference conductor R.

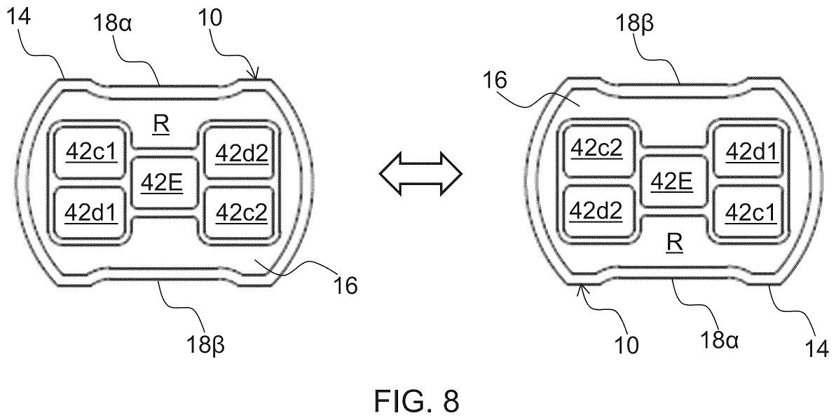

The insertion guide 38 of the fragrance unit 100 according to the present embodiment is configured in such a manner that, the cartridge 10 having an orientation to allow insertion and removal can be inserted and removed even when the cartridge 10 is rotated by 180° about the axis in the longitudinal direction of the cartridge 10. That is, the insertion guide 38 of the fragrance unit 100 is configured in such a manner that the cartridge 10 can be inserted or removed regardless of the up-and-down orientation of the cartridge 10. FIG. 8 shows, at the left and the right, the back surface of the cartridge 10 and the back surface rotated by 180° about the axis in the longitudinal direction of the cartridge 10, for comparison purposes.

The contact conductors 42c1 and 42c2 are at positions which are two-fold rotationally symmetric with the axis in the longitudinal direction of the cartridge 10 as a center. Here, with N being an integer greater than or equal to 2, the positions of N-fold rotationally symmetry refer to positions where, when the cartridge 10 is rotated by 360°/N about the axis in the longitudinal direction, each of the plurality of contact conductors moves to a position of another contact conductor before the rotation, among the plurality of contact conductors.

In the present embodiment, N equals 2 (N=2), and, when the cartridge 10 is rotated by 360°/2=180° about the axis in the longitudinal direction, one of the contact conductors 42c1 and 42c2 moves to the position of the other of the contact conductors 42c1 and 42c2 before the rotation. Similarly, the other of the contact conductors 42c1 and 42c2 moves to the position of the one of the contact conductors 42c1 and 42c2 before the rotation. That is, the contact conductor 42c1 moves to the position of the contact conductor 42c2 before the 180° rotation, and the contact conductor 42c2 moves to the position of the contact conductor 42c1 before the 180° rotation. Similarly, the contact conductor 42d1 moves to the position of the contact conductor 42d2 before the 180° rotation, and the contact conductor 42d2 moves to the position of the contact conductor 42d1 before the 180° rotation.

The contact point pin 52c which contacts the contact conductor 42c1 before the 180° rotation contacts the contact conductor 42c2 after the 180° rotation. Similarly, the contact point pin 52d which contacts the contact conductor 42d2 before the 180° rotation contacts the contact conductor 42d1 after the 180° rotation. The contact point pins 52a and 52b contact the contact conductor 42e and the reference conductor R, respectively, without a change before and after the 180° rotation.

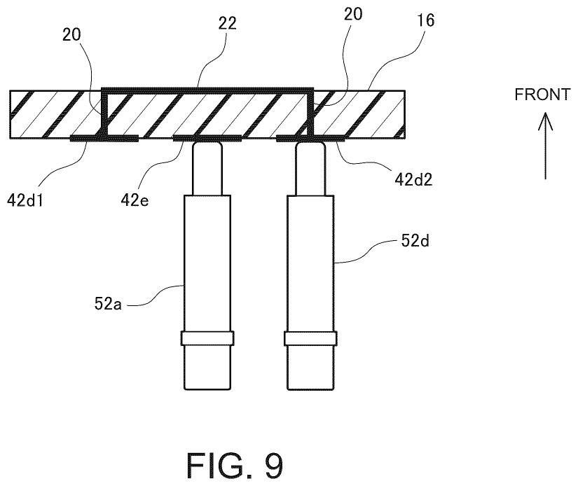

FIG. 9 is a cross-sectional diagram of the cartridge board 16, along a line BB of FIG. 7. From each of the contact conductor 42d1 and the contact conductor 42d2, a through hole 20 extends toward the front side, in the cartridge board 16. A tip of the through hole 20 extending from the contact conductor 42d1 and a tip of the through hole extending from the contact conductor 42d2 are connected to each other by a conductor pattern 22 provided on a front surface of the cartridge board 16. Therefore, the contact conductor 42d1 and the contact conductor 42d2 are electrically commonly connected (are in electrical conduction with each other) and have the same potential.

While FIG. 9 shows the structure related to the contact conductors 42d1 and 42d2, the structure is similar for the contact conductors 42c1 and 42c2. That is, the cartridge board 16 has a structure in which a through hole 20 extends from each of the contact conductors 42c1 and 42c2 toward the front side, with a tip of the through hole 20 extending from the contact conductor 42c1 and a tip of the through hole 20 extending from the contact conductor 42c2 being connected to each other by a conductor pattern 22 provided on the front surface of the cartridge board 16.

Therefore, even when the up-and-down orientation of the cartridge 10 is reversed from the state in which the cartridge 10 is inserted into the insertion guide 38, and the cartridge 10 is again inserted into the insertion guide 38 in the reverse orientation, the contact conductors 42c1 and 42c2 are connected to the contact point pin 52c, and the contact conductors 42d1 and 42d2 are connected to the contact point pin 52d.

Moreover, the contact conductor 42e is on a rotational axis in the longitudinal direction of the cartridge 10, and the reference conductor R surrounds the five contact conductors 42c1, 42d1, 42e, 42d2, and 42c2. Because of this, even when the up-and-down orientation of the cartridge 10 is reversed from the state in which the cartridge 10 is inserted into the insertion guide 38, and the cartridge 10 is again inserted into the insertion guide 38 in the reversed orientation, the contact conductor 42e contacts the contact point pin 52a, and the reference conductor R contacts the contact point pin 52b.

Therefore, even when the up-and-down orientation of the cartridge 10 is reversed, and the cartridge 10 is inserted into the insertion guide 38 in the reversed orientation, a state is realized in which the fragrance unit 100 reads the cartridge information from the cartridge 10. With this configuration, insertion of the cartridge 10 into the fragrance unit 100 is facilitated.

In this manner, in the cartridge 10 according to the present embodiment, the plurality of contact conductors 42c1, 42c2, 42d1, and 42d2 are at positions of the N-fold rotational symmetry about the axis in the longitudinal direction of the cartridge 10. N is an integer greater than or equal to 2, and, in the cartridge 10 of the present embodiment, N equals 2 (N=2). Here, for the purpose of the explanation, the integer, 2, of the present embodiment is described as N. The positions of the N-fold rotationally symmetry refer to positions in which, when the cartridge 10 is rotated by 360°/N about the axis in the longitudinal direction, each of the plurality of contact conductors moves to a position of another contact conductor before rotation, among the plurality of contact conductors.

Further, the contact conductors positioned at the same position when the cartridge 10 is rotated by 360°/N about the axis in the longitudinal direction are in electrical conduction with each other through the through hole 20, the conductor pattern 22, and the like. On the fragrance unit 100, the contact point pins are provided at positions corresponding to the contact conductors which are positioned at the same position when the cartridge 10 is rotated by 360°/N about the axis in the longitudinal direction.

In addition, the cartridge 10 and the insertion guide 38 of the fragrance unit 100 are configured in such a manner that, even when the cartridge 10 in the orientation to allow insertion and removal is rotated by 360°/N about the axis in the longitudinal direction, the cartridge 10 can be inserted and removed.

Therefore, even when the cartridge 10 is rotated by 360°/N about the axis in the longitudinal axis from the state in which the cartridge 10 is inserted into the insertion guide 38, and the cartridge 10 is again inserted into the insertion guide 38, a state is realized in which the fragrance unit 100 reads the cartridge information from the cartridge 10.

That is, even when the cartridge 10 in the orientation to allow insertion into the insertion guide 38 is rotated by 360°/N about the axis in the longitudinal direction, and the cartridge 10 is inserted into the insertion guide 38, a state is realized in which the fragrance unit 100 reads the cartridge information from the cartridge 10. With this configuration, the insertion of the cartridge 10 into the fragrance unit 100 is facilitated.

When some of the plurality of contact conductors disposed on the cartridge board 16 are disposed at positions of the N-fold rotational symmetry, the remaining contact conductors among the plurality of contact conductors may be positioned on the rotational axis in the longitudinal direction of the cartridge 10. Further, shapes and ranges of the remaining contact conductors may be determined such that, even when the cartridge 10 is rotated about the axis in the longitudinal direction, the contact point pins corresponding to the remaining contact conductors among the plurality of contact conductors contact the remaining contact conductors. For example, the remaining contact conductors may surround a periphery of the plurality of contact conductors disposed at the positions of the N-fold rotational symmetry.

In the above-described embodiment, the integer N is 2, but alternatively, N may be an integer greater than or equal to 3.

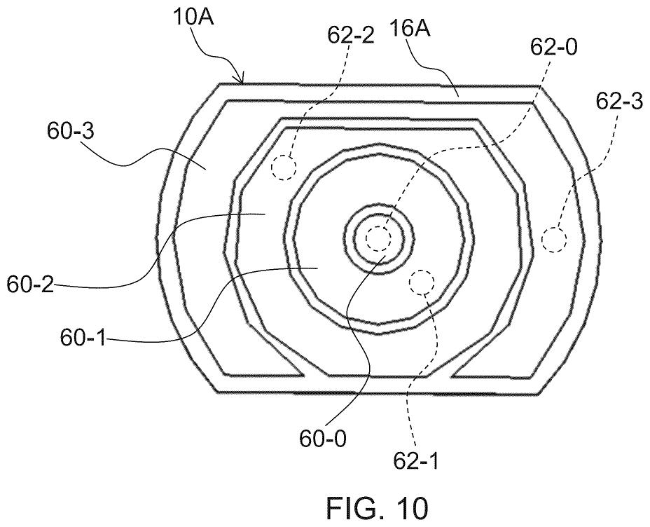

FIG. 10 shows a back surface of a cartridge board 16A of a cartridge 10A according to a second embodiment of the present disclosure. On the cartridge board 16A, a center contact conductor 60-0, a first annular contact conductor 60-1, a second annular contact conductor 60-2, and an arc-shape contact conductor 60-3 are provided.

The center contact conductor 60-0 is disposed near a center of the back surface of the cartridge board 16A. The first annular contact conductor 60-1 surrounds the center contact conductor 60-0 in an approximate circular shape, with the position of the center contact conductor 60-0 as the center. The second annular contact conductor 60-2 forms an approximate concentric circle with the first annular contact conductor 60-1. The arc-shape contact conductor 60-3 surrounds in an arc shape a region above the second annular contact conductor 60-2. In this manner, the first annular contact conductor 60-1 and the second annular contact conductor 60-2 are disposed approximately concentrically with different radii and centered at a center point at which the center contact conductor 60-0 is disposed. The arc-shape contact conductor 60-3 forms an arc with a lower extent of curvature than an extent of curvature of the second annular contact conductor 60-2 and surrounds the second annular contact conductor 60-2 in an annular shape, at an outer side of the second annular contact conductor 60-2. Here, the extent of curvature is defined, for example, as an inverse of a radius of curvature.

FIG. 10 shows, with black circles of dashed lines, positions of contact point pins provided at a deepest part of the insertion guide 38 of the fragrance unit 100. Tips of contact point pins 62-0, 62-1, 62-2, and 62-3 respectively contact the center contact conductor 60-0, the first annular contact conductor 60-1, the second annular contact conductor 60-2, and the arc-shape contact conductor 60-3.

As described, the cartridge 10A according to the second embodiment comprises the first annular contact conductor 60-1, the second annular contact conductor 60-2, and the arc-shape contact conductor 60-3, as the plurality of contact conductors provided at the tip of the cylindrically-shaped housing 14. The first annular contact conductor 60-1, the second annular contact conductor 60-2, and the arc-shape contact conductor 60-3 are configured in such a manner that, when the axis of the insertion/removal direction of the cylindrically-shaped housing 14 is viewed at an inner side, the first annular contact conductor 60-1 and the second annular contact conductor 60-2 form rings of different extents of curvature, and the arc-shape contact conductor 60-3 forms an arc. The first annular contact conductor 60-1, the second annular contact conductor 60-2, and the arc-shape contact conductor 60-3 are arranged in order from a higher extent of curvature to a lower extent of curvature from the inner side toward the outer side. The center contact conductor 60-0 is at a position surrounded by the first annular contact conductor 60-1, the second annular contact conductor 60-2, and the arc-shape contact conductor 60-3. When the cylindrically-shaped housing 14 is inserted into the insertion guide 38, the contact point pins 62-1, 62-2, and 62-3 serving as a plurality of contact terminals provided on the insertion guide 38 contact the corresponding one of the first annular contact conductor 60-1, the second annular contact conductor 60-2, and the arc-shape contact conductor 60-3, respectively.

According to such a configuration, even when the up-and-down orientation of the cartridge 10A is reversed from the state in which the cartridge 10A is inserted into the insertion guide 38, and the cartridge 10A is again inserted into the insertion guide 38 in the reversed orientation, the tips of the contact point pins 62-0, 62-1, and 62-2, and the contact point pin 62-3 respectively contact the center contact conductor 60-0, the first annular contact conductor 60-1, the second annular contact conductor 60-2, and the arc-shape contact conductor 60-3. Therefore, even when the up-and-down orientation of the cartridge 10A in the state which allows insertion into the insertion guide 38 is reversed, and the cartridge 10A is again inserted into the insertion guide 38 in the reversed orientation, a state is realized in which the fragrance unit 100 reads the cartridge information from the cartridge 10A. With this configuration, the insertion of the cartridge 10A into the fragrance unit 100 is facilitated.

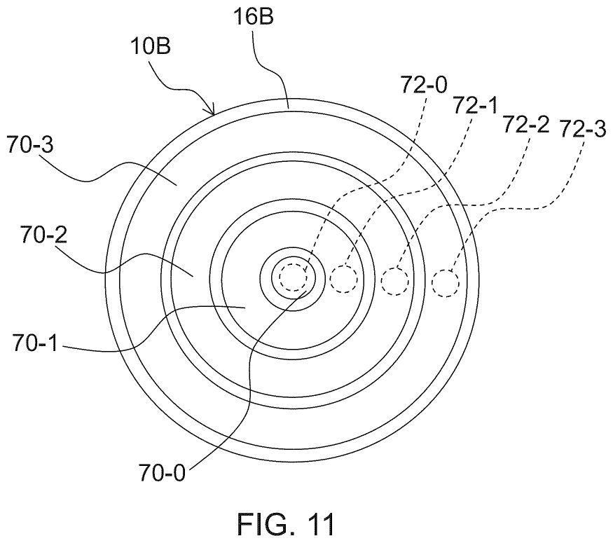

FIG. 11 shows a back surface of a cartridge board 16B of a cartridge 10B according to a third embodiment of the present disclosure. On the cartridge board 16B, a center contact conductor 70-0, a first annular contact conductor 70-1, a second annular contact conductor 70-2, and a third annular contact conductor 70-3 are provided. The cylindrically-shaped housing 14 may be formed in an approximate circular cylindrical shape.

The center contact conductor 70-0 is disposed near a center of the back surface of the cartridge board 16B. The first annular contact conductor 70-1 surrounds the center contact conductor 70-0 in an approximate circular shape with the position of the center contact conductor 70-0 as a center. The second annular contact conductor 70-2 forms an approximate concentric circle with the first annular contact conductor 70-1. The third annular contact conductor 70-3 forms an approximate concentric circle with the first annular contact conductor 70-1 and the second annular contact conductor 70-2. In this manner, the first annular contact conductor 70-1 through the third annular contact conductor 70-3 are disposed approximately concentrically with different radii and centered at a center point at which the center contact conductor 70-0 is disposed.

FIG. 11 shows, with black circles of dashed lines, positions of contact point pins provided at the deepest parts of the insertion guide 38 of the fragrance unit 100. Tips of contact point pins 72-0, 72-1, 72-2, and 72-3 contact the center contact conductor 70-0, the first annular contact conductor 70-1, the second annular contact conductor 70-2, and the third annular contact conductor 70-3, respectively.

In this manner, the cartridge 10B according to the third embodiment includes, as the plurality of contact conductors provided at the tip of the cylindrically-shaped housing 14, the first annular contact conductor 70-1 through the third annular contact conductor 70-3. The first annular contact conductor 70-1 through the third annular contact conductor 70-3 form rings of different extents of curvature, when viewing the axis of the insertion/removal direction of the cylindrically-shaped housing 14 at an inner side. The first annular contact conductor 70-1 through the third annular contact conductor 70-3 are arranged in an order from a higher extent of curvature to a lower extent of curvature, from an inner side toward an outer side. The center contact conductor 70-0 is at a position surrounded by the first annular contact conductor 70-1 through the third annular contact conductor 70-3. When the cylindrically-shaped housing 14 is inserted into the insertion guide 38, contact point pins 72-1 through 72-3 serving as a plurality of contact terminals provided on the insertion guide 38 respectively contact the corresponding ones of the first annular contact conductor 70-1 through the third annular contact conductor 70-3. In addition, the contact point pin 72-0 provided on the insertion guide 38 contacts the center contact conductor 70-0.

According to such a configuration, when the cartridge 10B is inserted in to the insertion guide 38, the tips of the contact point pins 72-0, 72-1, 72-2, and 72-3 contact the center contact conductor 70-0, the first annular contact conductor 70-1, the second annular contact conductor 70-2, and the third annular contact conductor 70-3, respectively, regardless of the rotational angle about the axis in the longitudinal direction of the cartridge 10B. Therefore, when the cartridge 10B is inserted into the insertion guide 38, regardless of the rotational angle about the axis of the longitudinal direction of the cartridge 10B, a state is realized in which the fragrance unit 100 reads the cartridge information from the cartridge 10B. With this configuration, the insertion of the cartridge 10B into the fragrance unit 100 is facilitated.

The cartridge for the vehicle-mounted accessory device, and the structure into which the cartridge is inserted, such as the insertion guide 38 according to the present disclosure, may alternatively be employed for other vehicle-mounted accessory devices. For example, the cartridge for the vehicle-mounted accessory device of the present disclosure may be employed for a connector for a charging operation of a remote controller.

1. A cartridge for a vehicle-mounted accessory device, the cartridge comprising:
a cylindrically-shaped housing that can be inserted into and removed from an insertion guide of a vehicle-mounted accessory device; and
a plurality of contact conductors provided at a tip of the cylindrically-shaped housing, wherein
the plurality of contact conductors are disposed at positions of N-fold rotational symmetry with an axis in an insertion/removal direction of the cylindrically-shaped housing as a center, wherein N is an integer greater than or equal to 2, and
when the cylindrically-shaped housing is inserted into the insertion guide, each of a plurality of contact terminals provided on the vehicle-mounted accessory device contacts a contact conductor, among the plurality of the contact conductors, corresponding to a rotational angle about the axis in the insertion/removal direction.

2. The cartridge for the vehicle-mounted accessory device according to claim 1, wherein
the cylindrically-shaped housing is guided by the insertion guide in the insertion/removal direction at a rotational angle of the N-fold rotational symmetry with the axis in the insertion/removal direction as a center.

3. The cartridge for the vehicle-mounted accessory device according to claim 2, further comprising:
a reference conductor provided at the tip of the cylindrically-shaped housing, and that surrounds, annularly or in an arc shape, the plurality of contact conductors disposed at the positions of the N-fold rotational symmetry wherein
when the cylindrically-shaped housing is inserted into the insertion guide, a reference contact terminal provided on the insertion guide contacts the reference conductor.

4. The cartridge for the vehicle-mounted accessory device according to claim 1, further comprising:
a center contact conductor provided at the tip of the cylindrically-shaped housing, and provided on a rotational axis of the N-fold rotational symmetry.

5. The cartridge for the vehicle-mounted accessory device according to claim 1, wherein
contact conductors, among the plurality of contact conductors, which are positioned at a same position when the cartridge is rotated by 360°/N about the axis in the insertion/removal direction from a certain rotational angle, are in electrical conduction with each other.

6. The cartridge for the vehicle-mounted accessory device according to claim 1, wherein
the vehicle-mounted accessory device is a fragrance generation apparatus.

7. A cartridge for a vehicle-mounted accessory device, the cartridge comprising:
a cylindrically-shaped housing that can be inserted into and removed from an insertion guide of a vehicle-mounted accessory device; and
a plurality of contact conductors provided at a tip of the cylindrically-shaped housing, wherein
the plurality of contact conductors form one or more rings and/or one or more arcs of different extents of curvature when viewing an axis in an insertion/removal direction of the cylindrically-shaped housing at an inner side, and are arranged in order from a higher extent of curvature to a lower extent of curvature, from an inner side toward an outer side, and
when the cylindrically-shaped housing is inserted into the insertion guide, each of a plurality of contact terminals provided on the insertion guide contacts a corresponding contact conductor among the plurality of contact conductors.

8. The cartridge for the vehicle-mounted accessory device according to claim 7, wherein
the plurality of contact conductors form one or more circles and/or one or more arcs of different radii of curvature, and are disposed concentrically.

9. The cartridge for the vehicle-mounted accessory device according to claim 7, further comprising:
a center contact conductor provided at the tip of the cylindrically-shaped housing, and provided at a position surrounded by the plurality of contact conductors.

10. The cartridge for the vehicle-mounted accessory device according to claim 7, wherein
the vehicle-mounted accessory device is a fragrance generation apparatus.
